(19) United States
(12) Patent Application Publication
(10) Pub. No.: US 2018/0072014 A1
(43) Pub. Date: Mar. 15, 2018

(54) DESIGN AND FABRICATION OF COLLAPSIBLE AND DEPLOYABLE STRUCTURES WITH PRESCRIBED SHAPES

(71) Applicants: Levi DUDTE, Cambridge, MA (US); Etienne VOUGA, Cambridge, MA (US); Lakshminarayanan MAHADEVAN, Cambridge, MA (US)

(72) Inventors: Levi DUDTE, Cambridge, MA (US); Etienne VOUGA, Cambridge, MA (US); Lakshminarayanan MAHADEVAN, Cambridge, MA (US)

(21) Appl. No.: 15/554,052

(22) PCT Filed: Mar. 4, 2016
(86) PCT No.: PCT/US16/20817

§ 371 Date: Aug. 28, 2017

Related U.S. Application Data
(60) Provisional application No. 62/128,650, filed on Mar. 5, 2015.

(51) Int. Cl. B31D 5/04

(52) U.S. Cl. CPC B31D 5/04; B65D 5/48034

(57) ABSTRACT

Miura-Ori-like origami, corresponding to a smoothly varying tessellation of unit cells, each of which is composed of a 2×2 grid of quadrilaterals, is employed to closely approximate a curved surface by one that can be easily collapsed and deployed. The unit cells do not necessarily perfectly repeat, but do vary smoothly across the origami pattern.

### CROSS-REFERENCE TO RELATED APPLICATION

This application claims priority to, and the benefits of, U.S. Ser. No. 62/128,650, filed on Mar. 5, 2015, the entire disclosure of which is hereby incorporated by reference.

### FIELD OF THE INVENTION

Embodiments of the present invention generally relate to foldable structures, and in particular to the design and fabrication of structures involving origami tessellations.

### BACKGROUND

In applications ranging from structures transported and deployed in outer space to outdoor gear that must be conveniently carried to be practical, the ability to cause a structure to reversibly fold or collapse into a more compact format is highly valued. Because of their simplicity and remarkable geometric properties, origami tessellations have received increased attention from mathematicians, physicists, engineers, and computer scientists as building blocks for foldable or deployable structures. Of particular interest are origami tessellations generated by folding along creases that tile the plane smoothly, such as the well-known periodic Miuri-ori pattern formed by tiling the plane with a unit cell of four parallelograms tiles and creasing along tile edges.

The suitability of the Miura-ori for engineering deployable or foldable structures is due to its high degree of symmetry embodied in its periodicity, and four important geometric properties: it can be rigidly folded (that is, it can be continuously and isometrically deformed from its flat, planar state to a folded state); it has only one isometric degree of freedom, with the shape of the entire structure determined by the folding angle of any single crease; it exhibits negative Poisson's ratio (folding the Miura-ori decreases its projected extent in both planar directions); and it is flat-foldable (that is, when the Miura-ori has been maximally folded along its one degree of freedom, all faces of the pattern are coplanar).

To date, there has been no systematic way to modify the Miura form to achieve a three-dimensional (3D) structure conforming to an arbitrary, untesselated design. In particular, it would be desirable to be able to create a tessellated structure that, when folded, conforms to or approximates arbitrary surfaces in three dimensions. Ideally, the structure would be rigidly foldable with one degree of freedom.

### SUMMARY

We have found that the “inverse” problem of fitting Miura-like origami tessellations to a surface with arbitrary intrinsic curvature can be solved for a large variety of such surfaces. For example, embodiments described herein use Miura-Ori-like origami, corresponding to a smoothly varying tessellation of unit cells, each of which is composed of a 2×2 grid of quadrilaterals, to closely approximate a curved surface by one that can be easily collapsed and deployed. The unit cells do not necessarily perfectly repeat, but do vary smoothly across the origami pattern. For generalized cylinders, constructed patterns are rigid-foldable and flat-foldable, and thus can be easily adapted to thick origami. For doubly curved surfaces, the approach described herein facilitates design of physically realizable tessellations. When the Miura-ori tessellations are not flat-foldable, a mechanical model of these surfaces may be used to quantify the strains and energetics associated with snap-through as the pattern moves from the flat to folded configuration. Flat-foldable structures that may be fabricated using the principles described herein include solar sails (i.e., arrays of photovoltaic material that may be launched in a compact form into space and there deployed into an expanded configuration with large surface area), shelters (such as tents), foldable batteries, antennas, containers and similar structures, “sandwich cores” (i.e., folded, curved origami-cores used to provide structural stability/rigidity to a surface structure with non-negligible thickness, where the folded origami connects two smooth surfaces—for example, in a helmet or an airfoil—or supports the weight of a single surface—for example, as an architectural facade, or forming the deployable/collapsible base of a “quarter-pipe” or “half-pipe” in extreme sports), “pop-up” cards based on origami (the origami-surface can be collapsed into the folded card, and deploys by unfolding into a target shape with the opening of the card), high-end decorative items (e.g., light fixtures, lamps, coffee-table supports, sculpture), decorative or functional packaging (e.g., providing an aesthetically distinctive, flexible protective shell that wraps around an item such as a wine bottle), and passive humidifiers.

Accordingly, in one aspect, the invention relates to a method of fabricating a collapsible surface conforming to a curved surface design. In various embodiments, the method comprises the steps of generating a Miura-Ori-like origami design conforming to the surface, the design (i) consisting of a smoothly varying tessellation of unit cells, each unit cell being composed of a 2×2 grid of quadrilaterals, and (ii) approximating the curved surface with arbitrary accuracy; and fabricating the surface by (i) fabricating the unit cells from a solid material and (ii) assembling the unit cells by foldably connecting them in accordance with the design, wherein the surface, when so constructed, is collapsible into a substantially flat state and reversibly expanded from the flat state into the curved surface. The pattern may be constructed in one whole piece or in several large pieces, each consisting of many unit cells. Once the pattern is generated, the physical surface may be realized in many ways, e.g., by creasing a large thin plate, assembling many small plates with hinges, etc.

In some embodiments, the tessellations vary in shape across the surface. The collapsible surface may be flat-foldable without fracture. For example, the design may have a plurality of nodes and be flat-foldable at each of the nodes.

In various embodiments, the origami design comprises at least one generalized cylinder. For example, each generalized cylinder may comprise at least one Miura-ori strip. In other embodiments, the origami design comprises at least one hyperboloid. The tessellation may have a pattern generated by a constrained optimization. For example, the optimization, au be specified over a mesh according to

$${min}_{{p}^{i}} f ( {p}^{i} , {p}_{0}^{i} ) s . t . {g}_{planarity} ( {p}^{i} ) = 0 , {g}_{develop} ( {p}^{i} ) = 0$$

where values of p₀ⁱ correspond to initial positions of vertices of the mesh, pⁱ are final positions of the vertices, g_{planarity} is a planarity constraint and g_{developability} is a developability constraint requiring, for example, that angles around each interior vertex of the design sum to 2π. The surface may have a negative Gauss curvature.

By “approximating” is meant a degree of similarity that permits key structural, mechanical and/or functional features of the original design to be retained in the fabricated surface. For example, depending on the application, the degree of similarity may exceed 80%, 90%, 95% or even 98% or 99%. The fabricated design, being tesselated, will not conform exactly to a smoothly contoured surface, but for many applications exact identity is not important.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1A-1D illustrate the geometry of generalized Miura-ori, with FIG. 1A showing planar periodic Miura-ori, FIG. 1B illustrating standard and modified Miura-ori unit cells and showing the mountain-valley folds, FIG. 1C showing mountain/valley fold orientations and the pattern of fixed/free nodes for numerical optimization (with the shaded area corresponding to one unit cell), and FIG. 1D illustrating constraints at nodes and facets.

FIGS. 2A-2C illustrate accuracy/effort trade-offs in origami tessellations, with FIG. 2A showing three Miura-ori approximations of a hyperboloid that differ from each other by a factor of ten in the number of faces (cells) per strip (n), FIG. 2B graphically depicting a simple cost function, C, that is the sum of the number of faces normalized by its maximum value (\hat{N}) and the Hausdorff distance normalized by its maximum value (\hat{d}_{H}) to the smooth hyperboloid as a function of the number of cells (faces) per unit strip (n), and FIG. 2C showing how the non-dimensional area of the curved Miura-ori approximation to the hyperboloid (normalized by the area of the smooth hyperboloid A/A₀), as the number of facets increases, approaches a constant greater than unity.

FIGS. 3A-3D show, respectively, an in-plane strip construction; the result when all points on one side of the strip shown in FIG. 3A are extruded on one side of the strip by T; the result of mirroring the strip over the construction plan to produce a single column of Miura-ori cells; and the result of translating and gluing copes of the column to create a generalized Miura-ori cylinder.

FIG. 4 graphically illustrates global flat-foldability using single-vertex fold angle relations.

FIG. 5 graphically depicts a hyperboloid of one sheet. This is an example of one particular target surface used to generate a conforming pattern.

### DETAILED DESCRIPTION

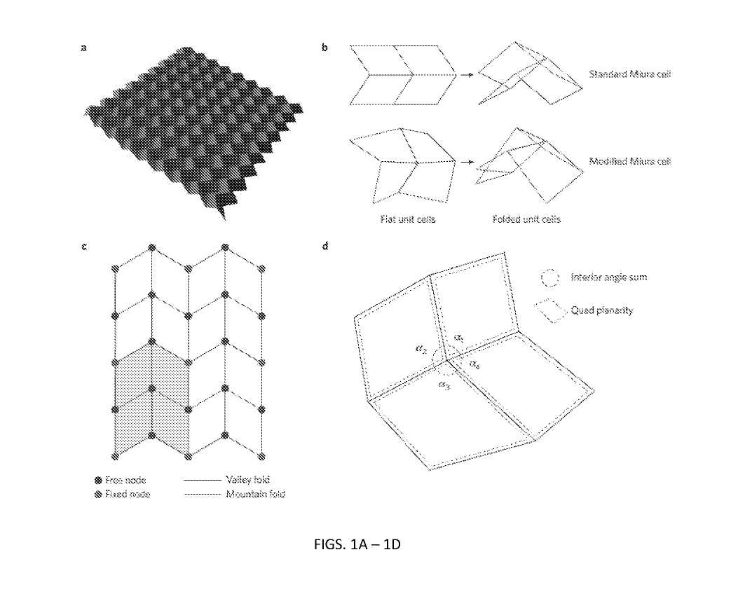

Origami is an art form that probably originated with the invention of paper in China, but was refined in Japan. The ability to create complex origami structures depends on folding thin sheets along creases, a natural consequence of the large-scale separation between the thickness and the size of the sheet. This allows origami patterns to be scaled; the same pattern can be used at an architectural level or at a nanometric level. Much of the complexity of the folding patterns arises from the possibilities associated with the basic origami fold—the unit cell associated with a four-coordinated mountain-valley structure that forms the heart of the simplest origami tessellation depicted in FIGS. 1A and 1C. Indeed, tiling the plane with this unit cell yields the eponymous Miura-ori. More generally, interest in the Miura-ori and allied patterns has recently been rekindled by an interest in mechanical metamaterials on scales that range from the architectural to the microscopic.

Given the simplicity of the Miura-ori pattern, a key question is whether, for an arbitrary surface with intrinsic curvature, there exists a Miura-ori-like tessellation of the plane that, when folded, approximates that surface. If so, it may be possible to make this pattern rigidly foldable with one degree of freedom. The ability to even partially solve this inverse problem allows compact, deployable structures of arbitrary complex geometry to be engineered. We have found that the problem can be solved for generalized cylinders using a direct geometric construction and for arbitrarily curved surfaces using a simple numerical algorithm. Modifications to the geometry of patterns fitting the same target surface may effectively tune their mechanical bistability.

Because the periodic Miura-ori pattern tiles the entire plane, generalized origami tessellations may be built from quadrilateral unit cells that are not necessarily congruent but vary smoothly in shape across the tessellation. An embedding of such a pattern in space can be represented as a quadrilateral mesh given by a set of vertices, with edges connecting the vertices and representing the pattern creases, and exactly four faces meeting at each interior vertex. A quadrilateral mesh of regular valence four must satisfy two additional constraints to be an embedding of a generalized Miura-ori tessellation: each face must be planar, and the neighbourhood of each vertex must be developable—that is, the interior angles around that vertex must sum to 2π as shown in FIG. 1D.

A generalized Miura-ori tessellation is guaranteed to possess some, but not all, of the four geometric properties of the regular Miura-ori pattern. An arbitrary unit cell has only one degree of freedom, and this local property guarantees that the global Miura-ori pattern, if it is rigid-foldable at all, must have only one degree of freedom. Moreover, because each unit cell must consist of three valley and one mountain crease, or vice versa, it must fold with negative Poisson's ratio. Unfortunately, no local condition is known for whether an origami pattern is flat-foldable; indeed, it has been shown that the problem of determining global flat-foldability is NP-complete (i.e., potentially unsolvable computationally in a reasonable time frame). However, several necessary flat-foldability conditions do exist, of which the two most pertinent are: first, if a generalized Miura-ori tessellation is flat-foldable, each pair of opposite interior angles around each vertex must sum to π (see FIG. 1D), and second, if there is a non-trivial generalized Miura-ori embedding (not flat or flat-folded) that satisfies Kawasaki's theorem (which provides a criterion for determining whether a crease pattern with a single vertex may be folded to form a flat figure), it is globally flat-foldable and rigid-foldable. In practice, enforcing a weaker version of Kawasaki's theorem does improve the degree to which a generalized Miura-ori tessellation is deployable and, in the case where a flat-foldable configuration cannot be found, the departure from rigid-foldability may be characterized by measuring the maximum strain required to deform or snap the bistable tessellation between flat and curved states—a desirable property for stable deployable structures.

These considerations facilitate formulation of the inverse Miura-ori problem: given a smooth surface M in R³ of bounded normal curvature, an approximation error ε, and a length scale s, does there exist a generalized Miura-ori tessellation that can be isometrically embedded such that the embedding has Hausdorff distance at most ε to M, and also has all edge lengths at least s? In particular, do there exist such tessellations that satisfy the additional requirement of being flat-foldable? Less formally, the question is whether it is possible to find optimal Miura-ori tessellations that can be used to conform to surfaces with single or double curvature—i.e., generalized developables, ellipsoids and saddles, and simple pairwise combinations of these—that might serve as building blocks for more complex sculptures.

The richness of the solution space may be appreciated by starting with a simple analytic construction for generalized cylinders and a numerical algorithm for generic, intrinsically curved surfaces. The generalized cylinder constructions—developable surfaces formed by extruding a planar curve along the perpendicular axis—are guaranteed to be rigid-foldable with one degree of freedom and flat-foldable, making them well-suited to applications involving freeform deployable and flat-packed structures. For more general surfaces M with intrinsic curvature, a conventional numerical optimization algorithm may be employed to solve the inverse problem, using the constraints that a quadrilateral mesh approximating M is a generalized Miura-ori if it satisfies a planarity constraint for each face, and a developability constraint at each interior vertex (see FIG. 1D). For a mesh with V vertices and F≈V faces, there are therefore 3V degrees of freedom and only V+F≈2V constraints, suggesting that the space of embedded Miura-ori tessellations is very rich; it is therefore plausible that one or more such tessellations that can approximate a given M can be found.

The approach described herein allows this space to be explored, constructing tessellations for surfaces of negative, positive, and mixed Gauss curvature. It is found that whereas surfaces of negative Gauss curvature, such as the helicoid and the hyperbolic paraboloid, readily admit generalized Miura-ori tessellations for a variety of initial guesses for pattern layout, the space of Miura-ori patterns approximating positively curved surfaces such as the sphere is less rich. Indeed, choosing initial layouts that respect the rotational symmetry of the surface is particularly important for rapid convergence in the latter situation, and also yields surfaces of mixed curvature, such as formed by gluing all pairwise combinations of patches—that is, 0/+, 0/−, +/− curvature.

Explicit Construction for Generalized Cylinders

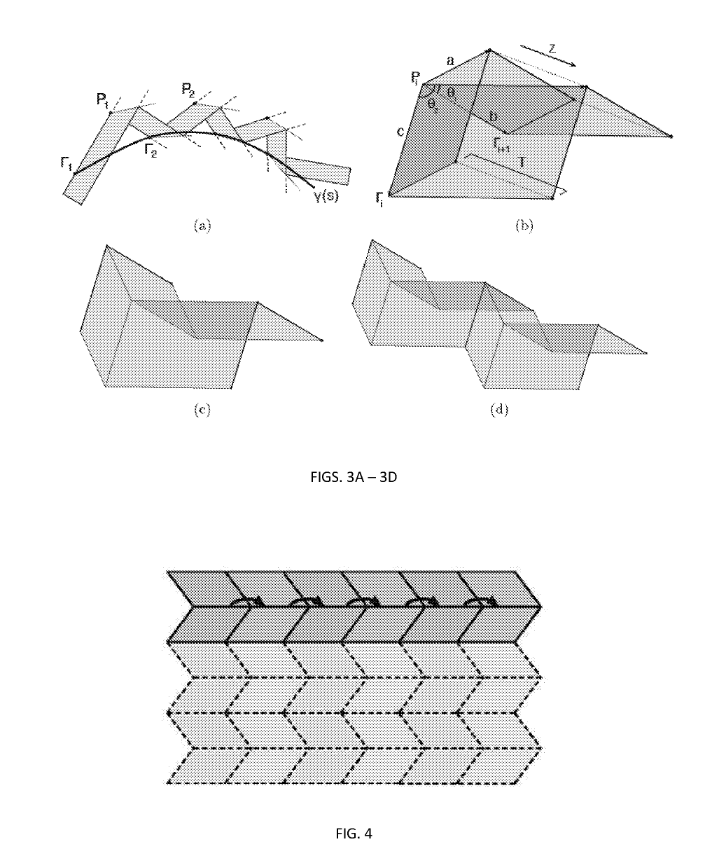

The simplest case is that of generalized cylinders: developable surfaces formed by extruding a planar curve along the perpendicular axis. One approach to creating Miura-ori structures it to approximate generalized cylinders—i.e., surfaces r(s, t)=γ(s)+t\hat{z} for a plane curve γ—by flat-foldable generalized Miura-ori tessellations. γ(s) may be approximated by a piecewise-linear discrete curve passing through N nodes Γᵢ, and a set of N control points Pᵢ may be chosen on one side of the curve for the Miura-ori structure to pass through. With reference to FIG. 3A, consider a strip of paper with uniform width, shown in blue, and rigidly align the left boundary of the strip with the line passing through Γ₁ and P₁. Now draw a line (shown dashed) to the next node Γ₂ and fold the strip along the bisector of Γ₁P₁ and P₁Γ₂, shown in red. Continuing this process along all N nodes and control points, with each crease edge given by a bisection yields a construction that has 2N free parameters—the position each control point.

The resulting pattern can be optimized for ε or other design goals such as regularity of the quadrilaterals, etc. and indeed several such strips—these constructions are herein referred to as Miura-ori strips—can be glued together into a generalized Miura-ori pattern approximating a generalized cylinder of any curvature, such as extruded spirals or sine waves that are completely flat-foldable. Given a extrusion parameter T, several copies of a Miura-ori strip can be glued into a generalized Miura-ori tessellation approximating the generalized cylinder r(s, t)=γ(s)+t\hat{z}. Take strip j and displace the right side of the strip by T in the \hat{z} direction, if j is odd, or the left side, if j is even (see FIG. 3D), then translate the entire strip rigidly in the \hat{z} direction by jT to complete a new column of Miura-ori cells. It is clear that the strips align as a quadrilateral mesh, that they approximate r, and that the faces of the mesh are planar. It remains to be shown that this mesh is developable at the vertices.

Consider θ₁ and θ₂, the interior angles of two consecutive quads in the strip construction, as shown in FIG. 3B. Because this strip will be mirrored to form a column of Miura-ori cells, developability requires that θ₁+θ₂=π. Denoting by a, b, c the lengths of the edges marked in FIG. 3B, a coordinate system with a(T)=(A, 0, T), b=(B₁, B₂, 0) and c=(C₁, C₂, 0) may be established for some A, Bᵢ, Cᵢ, and

$$cos {θ}_{1} ( T ) = \frac{{AB}_{1}}{\sqrt{{A}^{2} + {T}^{2}} \sqrt{{B}_{1}^{2} + {B}_{2}^{2}}}$$

$$cos {θ}_{2} ( T ) = \frac{A {C}_{1}}{\sqrt{{A}^{2} + {T}^{2}} \sqrt{{C}_{1}^{2} + {C}_{2}^{2}}}$$

$$Setting K ( T ) = \frac{A}{\sqrt{{A}^{2} + {T}^{2}}} we have$$

$$cos {θ}_{1} ( T ) + cos {θ}_{2} ( T ) = K ( T ) ( cos {θ}_{1} ( 0 ) + cos {θ}_{2} ( 0 ) ) = 0$$

since by construction ƒ₁(0)+θ₂(0)=π and so cos θ₁(0)+cos θ₂(0)=0. Therefore, θ₁(T)+θ₂(T)=π and the tessellation is developable for any T.

Additionally, when consecutive strips of the tessellation are mirrored, the sum of opposite interior angles about any vertex is also θ₁(T)+θ₂(T), and so the construction yields a tessellation that satisfies Kawasaki's condition (locally flat-foldable) at every node. The tessellation is trivially globally flat-foldable and rigid-foldable, which can be seen by observing that in any folded state the width of each strip in the z direction is constant and all strips are identical up to rigid translation and reflection (see FIG. 4).

In contrast with generalized cylinders, solutions to the numerical optimization problem are guaranteed only to be discrete developable, and are not necessarily flat- or rigid-foldable: the tessellation can be embedded without strain so that it approximates M, or so that it is planar, but generally these are isolated states and folding/unfolding the pattern requires snapping through strained configurations. To characterize the failure of a generalized Miura-ori tessellation to be rigid-foldable, a conventional, physically based numerical simulation may be used: instead of modelling each quadrilateral face of the pattern as rigid and planar, the pattern is divided it into a pair of triangles and modeled as a thin plate with an elastic hinge. Beginning with the folded configuration, one crease in the pattern is chosen and its bending angle is incrementally decreased from its folded value θ=θₘₐₓ to its flat value θ= [symbol] . For each intermediate value of the angle, the pattern is allowed to relax to static equilibrium; the strain energy of the equilibrium configuration measures the geometric frustration of that intermediate state and determines whether the structure can be flat-folded without fracture.

To tune this bistability, Kawasaki's theorem may be replaced with a tolerance on the residual associated with deviations from flat-foldability given by |π−α₁−α₃|≦ε_{ff} 1. Because flat-foldability implies rigid-foldability for nontrivial configurations, decreasing ε_{ff} is found to yield Miura-ori patterns that are closer to rigid-foldable.

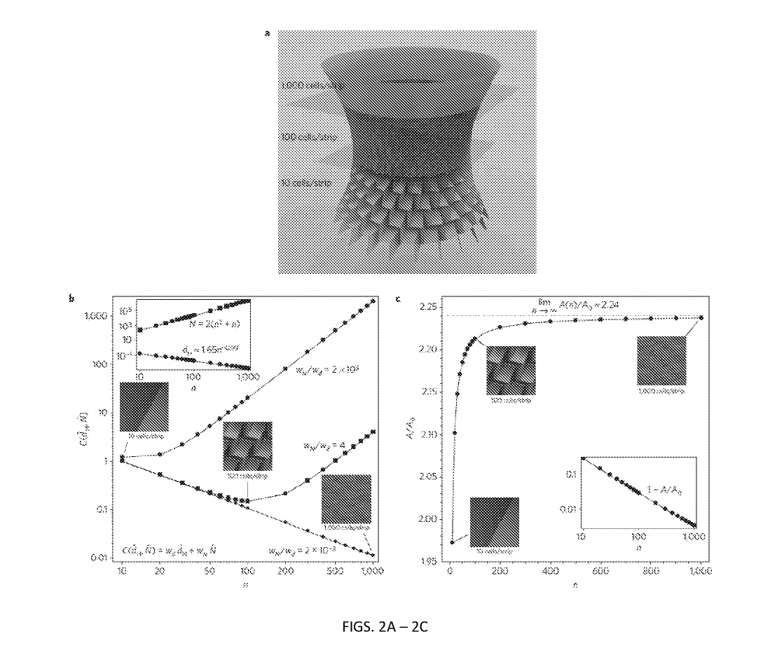

To assess the viability of the present approach in creating a physical object, it is useful to assess the accuracy of using a folded structure to approximate the object's smooth surfaces. Clearly, as the individual folds become finer the resulting structure will conform more closely to the desired target and will require more effort to fabricate. FIGS. 2A-2C illustrate the trade-off between accuracy and effort. The origami representation of the hyperboloid shown in FIG. 2A is modeled using three different values for the density of cells (n), each separated by an order of magnitude. A simple cost function associated with the weighted sum of the number of faces (N) and the Hausdorff distance (d_{H}) to the smooth surface facilitates computation of the minimum cost as a function of the relative weight penalizing effort and accuracy; as expected, when facets are cheap, one can get high accuracy at low cost, but as they become more expensive, for the same cost, accuracy plummets as shown in FIG. 2B. Furthermore, as the number of facets increases, the area of the folded origami tessellation scaled by the true area of the smooth surface it approximates asymptotically approaches a constant as shown in FIG. 2C.

Curved Surfaces

For surfaces with intrinsic curvature, let M be the target surface that is to be approximated, and parameterize the embedded generalized Miura-ori tessellation by a quadrilateral mesh with vertices pⁱ. As discussed above, the mesh is generalized Miura-ori if it satisfies a planarity constraint for each face, and a developability constraint at each interior vertex. For a mesh with V vertices and F≈V faces, there are therefore 3 V degrees of freedom and only V+F≈2V constraints, suggesting that the space of embedded Miura-ori tessellations is very rich; it is therefore plausible that one of more such tessellations can be found that well-approximate a given M.

Indeed, in practice for many classes of surfaces a tessellation can be found by numerical optimization. The method consists of the following steps:
a. Guess initial positions p₀ⁱ for the vertices of the mesh based on quad mesh parameterization of M; this guess closely approximates M but does not necessarily satisfy the planarity, developability or additional constraints.
b. Pin the corners of each unit cell guess to the quads in M, ensuring that the generalized Miura-ori surface remains close to M.
c. Solve the below constrained optimization problem to produce a developable pattern which approximates M. Note that this pinning pattern leaves at least one free node between all fixed nodes in optimization.

$${min}_{{p}^{i}} f ( {p}^{i} , {p}_{0}^{i} ) s . t . {g}_{planarity} ( {p}^{i} ) = 0 , {g}_{develop} ( {p}^{i} ) = 0$$

where the objective function ƒ and the constraint functions are described in more detail below.

The representation of the curved target surface is a regular, orientable quad mesh (all interior nodes have valence four and the normals of the quads are orientable), herein referred to as the “base mesh.” The base mesh can be obtained by discretizing the two families of curves formed by a parameterization of the target surface and forms the basis for the initial structure guess provided to the optimization routine. The initial guess for the positions of all nodes in the Miura-ori structure may be obtained by populating each individual quad with nine nodes (four at corners, four at the edges and one central node); displacing the edge and central nodes to construct a Miura-ori unit cell guess at each quad according to chosen orientations and local length scales; and merging nodes at interior edges by averaging their positions. The positions of the four undisplaced corner nodes in each “unit cell” are required to remain fixed throughout optimization. This ensures that the solved structure closely approximates the target surface and further flexibility in designing patterns.

The planarity and developability constraints can both be formulated in terms of the vertex positions pⁱ. For a quadrilateral face with vertices p^{a}, p^{b}, p^{c}, p^{d} oriented clockwise, planarity is equivalent to vanishing of the tetrahedral volume

g_{planarity}=[(p^{b}−p^{a})×(p^{c}−p^{a})]·(p^{d}−p^{a}).

Developability requires that the angles around each interior vertex sum to 2π. In other words, if the neighbors of vertex i are n₁, . . . , nₘ, oriented clockwise, the developability constraint is given by

$${g}_{develop} = 2 π - {\sum }_{j = 1}^{m} ∠ ( {p}^{{n}_{i}} - {p}^{i} , {p}^{{n}_{j + 1}} - {p}^{i} )$$

where the angle between two vectors can be computed robustly using

∠(v,w)=2a tan 2(∥v×w∥,∥v∥∥w∥+v·w).

For the numerical optimization, the Jacobians of both constraints are required. Formulas for these derivatives can be readily computed analytically.

An origami structure is called “flat-foldable” if it has a folded state in which all of its faces are coplanar (i.e., every face has moved from one plane, the initial paper, to a second plane, the flat-folded state). Consider single flat-folded vertex with four folds. One of the folds will have opposite orientation from the other three. The unique fold can be either of the two folds which do not touch the largest α, and will be tucked inside the other folds in the flat-folded state. In the flat-folded state, consecutive angles interior angles have opposite orientations around the vertex, and walking around this vertex is equivalent to swinging back and forth in the flat-folded state by the a values. Assuming developability, we know that

α₁+α₂+α₃+α₄=2π.

Because opposite pairs of interior angles share orientation in the flat-folded state, the sums of these pair must be equal (no net change when walking around the entire vertex).

α₁+α₃=α₂+α₄

From these two statements we can see that and

α₁+α₃=π

and

α₂+α₄=π.

In practice, it may not be possible to obtain exact flat-foldability on intrinsically curved surfaces. However, the standard flat-foldability constraints can be broken into inequalities that express bounds on a flat-foldability residual. Notice that we have a single scalar at each interior vertex which represents the flat-foldability residual.

r_{ff}=π−(α₁+α₃)=−(π−(α₂+α₄))

Introducing a tolerance ε on r_{ff} in the form of a pair of inequality constraints allows the each pair of alternating angles at an interior vertex to sum to a value within ε of π.

g_{flat-foldability}(pⁱ)=±r_{ff}−ε≦0

In the limit ε→0 these inequalities reduce to the standard equality Kawasaki condition.

Special Cases: Triangulated Pattern

For some examples, the developability constraint residuals fail to vanish completely. Typically these non-zero values are on the order of at most 1e−6. These residuals can still introduce error in the layout process, however, so in these cases a second phase of optimization may be employed: (a) introduce additional degrees of freedom in the optimization by dropping the quad planarity constraint, (b) triangulate the pattern so that each interior node has six incident edges (and therefore six incident interior angles), and (c) solve g_{develop}=0 over six angles rather than four at each interior node.

Special Cases: Normalized Quad Planarity

Because the quad planarity constraint g_{planarity}(pⁱ)=0 is just the volume of the quad, it scales as L³ with the length L of the pattern edges. In many instances these constraints may be solved to arbitrary precision and the scaling is irrelevant. For the hyperboloid, however, patterns may be computed over two orders of magnitude of pattern resolution, so the scaling of g_{planarity} becomes relevant: more highly resolved patterns can more easily satisfy quad planarity by virtue of their smaller length scales. This may be addressed by solving a normalized version of quad planarity:

$${g}_{planarity - norm} = \frac{{g}_{planarity}^{j}}{{L}_{j}^{3}} = 0 ,$$

where Lⱼ is a length scale associated with the initial geometry of the j^{th} quad. We choose Lⱼ to be the mean of the four initial side lengths of quad j.

Objective Function and Numerical Optimization

The objective function minimizes changes in the lengths of pattern edges and cross edges of the initial guess. Edge i with current length Lⁱ and initial length L₀ⁱ contributes

$${E}_{i} = \frac{1}{2 {L}_{0}^{i}} {( {L}^{i} - {L}_{0}^{i} )}^{2} .$$

Because this energy is not balanced against other terms, a stiffness prefactor may be neglected. The objective function is zero at the beginning of each run and

$$\sum \frac{M}{i = 1} {E}_{i}$$

for a structure of M total edges (pattern and cross) thereafter. The purpose of the objective function is to preserve the initial user-provided positions as closely as possible during optimization (Eᵢ has no physical significance).

Numerical optimization may be performed in MATLAB using the Interior Point algorithm of fmincon. Fixed nodes can be implemented either as linear (which require no Jacobian) or simply by leaving these variables out of pⁱ. Analytic Jacobians may be provided for planarity and developability constraints (non-linear equality) and flat-foldability constraints (non-linear inequality). Successful optimizations typically find minima and satisfy constraints by a maximum residual of 1e-10 within several hundred iterations.

Note that satisfying g_{planarity}=0 and g_{develop}=0 guarantees the existence of only two states (three counting the mirror symmetric configuration obtained by flipping all MV assignments) of the curved Miura-ori structure: a single folded configuration in R³ and a developed pattern in R². The existence of other folded states of the pattern and, in particular, the existence of a continuous, isometric global motion from flat to solved states (i.e. a rigid folding) are also of interest. The existence of a rigid folding of a quad-based.

A generic quadrilateral structure is rigid-foldable if it is everywhere locally at-foldable (satisfies the Kawasaki condition) and a non-trivial configuration (neither at nor at-folded states) of the structure exists. These are sufficient conditions for the existence of a rigid folding motion from flat to flat-folded, passing through the non-trivial configuration. This means that if it is possible to solve for a folded state of a curved Miura-ori structure with flat-foldability enforced exactly at all interior nodes, a rigid-foldable structure with one DOF is guaranteed. Such a structure would be able to fold from flat to its solved state (non-trivial configuration) and past its solved state to a flat-folded state (all faces are coplanar and all fold angles are ±π).

Simulation

Using the hyperbolic paraboloid pattern (hypar), a single fold is chosen near the center of the pattern. This fold is then constrained to incrementally changing fold angles from solved to at in simulation, the actuation of which propagates throughout the structure by the equilibration of bending energies in the quads, effectively unfolding the pattern mechanically. All edge lengths remain constant (enforced by nonlinear constants) during simulation, and thus the computed folding motion is rigid.

Stating this procedure formally, the following optimization problem is solved

$${min}_{{p}^{i}} f ( {p}^{i} , {p}_{0}^{i} ) s . t . {g}_{edges} ( {p}^{i} ) = 0 , {g}_{fold} ( {p}^{i} ) = 0 ,$$

is the sum of all bending energies in the quad faces,

g_{edges}(pⁱ)=∥eₖ∥−Lₖ

is the edge length constraint, and is enforced at all edges with initial lengths Lₖ in the triangulated pattern, and

g_{fold}(pⁱ)=θ−θ_{pinch}

is the pinched fold angle constraint, enforced at a single fold in the interior of the pattern with θ its fold angle and θ_{pinch} the prescribed fold angle. Each incremental optimization takes the equilibrium node positions at the previous intermediate folding configuration as. p₀ⁱ.

Note that the only bending energies present in fare all within the quad faces. No fold angle, which resides at an interior edge between two adjacent quads, contributes to the objective function. And with the exception of the pinched fold, all fold angles are unconstrained and can move freely during optimization.

To create physical structures, the bending stiffnesses assigned in simulation is related to the Young's modulus and bending stiffness of the material/structure to be fabricated. A suitable bending model is based on adjacent triangles in each flat quad, in which case the folding of a triangle pair is connected to the uniform bending of a linearly elastic material piece of the same area and thickness.

Consider a triangle pair with areas A₁ and A₂ and shared edge length L. This pair has the same area as a rectangle of width w=L/2 and length a=2(A₁+A₂)/L. If this rectangle is bent uniformly along its length into a circular arc also of length a, the radius of curvature of this arc is R=a/θ, where θ is the fold angle (i.e. exterior to the dihedral angle between the two faces). This comes from the fact that α/2+(π−θ)/2+π/2=π.

A uniformly bent sheet with length a, constant thickness h, second moment of inertia I and Young's modulus E has strain energy due to stress along its length.

U_{b}^{θ}=½EIκ²a,

where κ is the curvature of the sheet's mid-plane. The quantity I=∫_{A}^{z2/dA} is computed for the bent sheet where A is the cross-sectional area, z is in the direction of the thickness and L/2 is the width.

Substituting I and κ=1/R gives

$${U}_{b}^{θ} = \frac{1}{48} \frac{{ELh}^{3} a}{{R}^{2}} ,$$

Equating this to the discrete bending energy model fj above gives

$$\frac{1}{2} {k}_{j} {θ}^{2} = \frac{1}{48} \frac{{ELh}^{3} a}{{R}^{2}} ,$$

where all parameters now belong to the two triangles inside quad j. Substituting R=a/θ gives

$$\frac{1}{2} {k}_{j} {θ}^{2} = \frac{1}{48} \frac{{ELh}^{3}}{a} {θ}^{2} .$$

Substituting a=2(A₁+A₂)/L gives our final bending stiffness k.

$${k}_{j} = \frac{1}{48} ( \frac{{L}^{2}}{{A}_{1} + {A}_{2}} ) {Eh}^{3}$$

Suitable parameter values include E=10⁹ N/m² and h=10⁻⁴ m, which are reasonable values of paper-like material, and to compute k the total bending energies are non-dimensionalized by the largest observed bending energy in a single material quad across all simulations, 9.764×10⁻⁸ J.

Simulations reveal that a larger flat-foldability residual leads to a higher energetic barrier between the flat and folded configurations. This bistability is likely a desired property in deployable structures that need to be (at least) locally stable.

It is natural to expect that as the resolution of a generalized Miura-ori surface is increased, its target surface may be approximated more accurately. This may be demonstrated for hyperboloids of one sheet, which exhibit a number of advantageous properties:

Negative Gauss curvature: Negatively curved surfaces are natural settings fitting generalized Miura-ori surfaces.

Rotational symmetry: The entire surface can be reduced to a single symmetric strip, which significantly reduces the computational demands of increased surface resolution in optimization. In particular, the size of the dense Jacobian provided to fmincon is quadratic in the number of unit cells per symmetric strip, rather than quartic, which would be the case without rotational symmetry.

Ruled surface: Conveniently, the hyperboloid has two symmetric families of rulings. Taken together, these families form a natural base mesh for optimization, so the choice of symmetric strip is not arbitrary, but rather given by the geometry of the hyperboloid and the desired resolution.

A hyperboloid of one sheet with waist radius a and rotational symmetry about the z-axis is given implicitly by

$$\frac{{x}^{2}}{{a}^{2}} + \frac{{y}^{2}}{{a}^{2}} - \frac{{z}^{2}}{{c}^{2}} = 1.$$

Choosing a=\sqrt{2} and c=1, simply for aesthetics, this surface can be parameterized by

x(t,v)=cos t+v(±sin t−cos t)

y(t,v)=sin t+v(∓cos t−sin t)

z(t,v)=2(v−½).

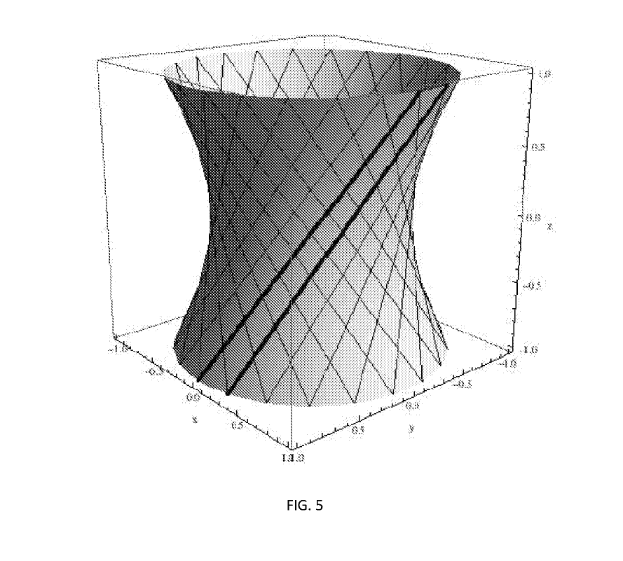

Herein we will focus on the surface patch given by tε[0; 2π), vε[0, 1]. The sign change in the parameterization gives two families of rulings (see FIG. 5). A single ruling, which runs diagonally on the surface of the hyperboloid, can be obtained by holding t constant and varying v. This parameterization is convenient because at v=0 we have the bottom circular boundary of the surface patch of interest. By sampling the rulings families over an even number of uniform intervals along the bottom circle, we can construct the diagonal grid seen in FIG. 5. Furthermore, if we divide the bottom circle into 2(n+1) arcs and extend rulings from the endpoints of these arcs, each diagonal, rotationally symmetric strip in the base mesh will have n quads (giving 2n(n+1) quads over the whole hyperboloid). The symmetry between rulings families also guarantees that the left and right nodes in each quad are themselves rotationally symmetric. All of the nodes in the base mesh remain fixed during optimization, allowing us to exploit the underlying symmetry of the base mesh.

The Hausdorff distance d_{H} is defined as the maximal distance between the points in one set and their closest points in another set, as viewed from both sets. More formally, for two sets M and S, d_{H} is given by

d_{H}(M,S)=max[d(M,S),d(S,M)]

d(M,S)=max[d(x,B)],∀xεM

d(x,S)=min [d(x,y)],∀ᵢⱼεS,

Denoting the Miura-ori hyperboloid M and the target hyperboloid S, we compute d(M, S) between each Miura-ori hyperboloid and the target surface computationally, as no analytic expression of distance from a point in space to the hyperboloid surface exists, and set this equal to d_{H}(M, S). Because the target hyperboloid is a continuous surface consisting of infinite points we cannot compute d(S, M), but we note that in this particular case d_{H}(M, S)=d(M, S), up to some error bound/

We construct a cost function from weighted, linear combinations of the data sets d_{H} (Hausdorff distance between Miura-ori and target hyperboloids) and N (total number of unit cells in the Miura-ori hyperboloid). We normalize each set by its largest value to produce

$$\hat{{d}_{H}} = \frac{{d}_{H}}{{‖ {d}_{H} ‖}_{∞}} and \hat{N} = \frac{N}{{‖ N ‖}_{∞}} .$$

The cost function C is a weighted sum of \hat{d}_{H} and Ñ̂(weights w_{d} and w_{N}, respectively).

C=w_{d}\hat{d}_{H}+w_{N}\hat{N}

By tuning the ratio w_{N}/w_{d} we can produce cost functions with different minima and therefore different optimal Miura-ori hyperboloids.

Because all quads in the Miura-ori hyperboloids are planar, we simply sum their areas to compute the total area of a structure. These areas converge in the limit of strip resolution n→∞ and the area asymptote A₀ for the Miura-ori hyperboloids is ˜24:13, whereas the actual area of the smooth hyperbolic target patch is ˜10.77. This factor of ˜2.24 different could be likely be reduced with different initial position parameters, but we expect any reduction to be minimal. Our convergent Miura-ori approximation constitutes an isometric wrapping of the hyperboloid.

Design and Construction

Generating the Miura-Ori-like origami design in accordance with the above-described techniques may be achieved using a computer programmed to read a file describing a desired surface and to execute steps for creating the Miura-Ori-like origami design conforming approximately thereto. The resulting design may be physically fabricated in solid form using any suitable material for the unit cells, and assembling them in accordance with the design. In some embodiments, the computer returns a computational (e.g., CAD) description of the unit cells, which may be fabricated using a 3D printer, laser cutter or other automated fabrication equipment capable of using the computer-generated design. The unit cells may be assembled into the finished structure manually or by automated means that include stamping or forging.

Design generation as described above may be implemented by computer-executable instructions, such as program modules, that are executed by a conventional computer. Generally, program modules include routines, programs, objects, components, data structures, etc. that performs particular tasks or implement particular abstract data types. Those skilled in the art will appreciate that the invention may be practiced with various computer system configurations, including multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The general-purpose computer may include a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the analytical functions described within. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of fabricating a collapsible surface conforming to a curved surface, the method comprising the steps of:
generating a Miura-Ori-like origami design conforming to the surface, the design (i) consisting of a smoothly varying tessellation of unit cells, each unit cell being composed of a 2×2 grid of quadrilaterals, and (ii) approximating the curved surface with arbitrary accuracy; and
fabricating the surface by (i) fabricating the unit cells from a solid material and (ii) assembling the unit cells by foldably connecting them in accordance with the design, wherein the surface, when so constructed, is collapsible into a substantially flat state and reversibly expanded from the flat state into the curved surface.

2. The method of claim 1, wherein the tessellations vary in shape across the surface.

3. The method of claim 1, wherein the collapsible surface is flat-foldable without fracture.

4. The method of claim 1, wherein the design has a plurality of nodes and is flat-foldable at each of the nodes.

5. The method of claim 1, wherein the origami design comprises at least one generalized cylinder.

6. The method of claim 5, wherein each said generalized cylinder comprises at least one Miura-ori strip.

7. The method of claim 1, wherein the origami design comprises at least one hyperboloid.

8. The method of claim 1, wherein the tessellation has a pattern generated by a constrained optimization.

9. The method of claim 8, wherein the optimization is specified over a mesh according to
$${min}_{{p}^{i}} f ( {p}^{i} , {p}_{0}^{i} ) s . t . {g}_{planarity} ( {p}^{i} ) = 0 , {g}_{develop} ( {p}^{i} ) = 0$$
wherein values of p₀ⁱ correspond to initial positions of vertices of the mesh, pⁱ are final positions of the vertices, g_{planarity} is a planarity constraint and g_{developability} is a developability constraint.

10. The method of claim 9, wherein the developability constraint requires that angles around each interior vertex of the design sum to 2π.

11. The method of claim 9, wherein the surface has a negative Gauss curvature.

12. The method of claim 1, wherein the fabrication step comprises constructing the unit cells from a solid material in a single large piece.

13. The method of claim 12, wherein the fabrication step comprises creasing a large thin plate.

14. The method of claim 1, wherein the fabrication step comprises constructing the unit cells from a solid material in a plurality of pieces.

15. The method of claim 14, wherein the fabrication step comprises assembling a plurality of small plates with hinges.
